(19) United States
(12) Patent Application Publication
(10) Pub. No.: US 2010/0133393 A1
(43) Pub. Date: Jun. 3, 2010

(54) WIRE HOLDING MECHANISM, IMAGE FORMING APPARATUS AND METHOD OF MAINTAINING A WIRE

(75) Inventor: Takeshi Yoshida, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/561,847

(22) Filed: Sep. 17, 2009

(30) Foreign Application Priority Data
Nov. 28, 2008 (JP) 2008-304163

(51) Int. Cl. F16L 3/08

(52) U.S. Cl. 248/74.1

(57) ABSTRACT

A wire holding mechanism includes: a frame having an attachment hole and an engagement portion, and a holding member detachably attached to the attachment hole. The holding member includes a rotation shaft rotatably supported by the attachment hole, a flange portion formed on a first end of the rotation shaft so as to prevent the holding member from coming out, an arm portion extending radially outward from the second end of the rotation shaft such that the arm portion is rotatable above the attachment surface, and a leg portion disposed between the flange portion and the arm portion. The holding member is inserted in the attachment hole at a first position, and, can be moved to a second position, the arm portion engages with the engagement portion and restricts movement of a wire.

### INCORPORATION BY REFERENCE

This application is based upon and claims the benefit of priority from the corresponding Japanese Patent application No. 2008-304163, filed Nov. 28, 2008, the entire contents of which are incorporated herein by reference.

### BACKGROUND

1. Field of the Invention

The present invention relates to a wire holding mechanism that restricts the movement of a wire located along a predetermined surface, to an image forming apparatus and to a method of maintaining a wire.

2. Description of the Related Art

In existing image forming apparatuses, such as printers and copiers, electric wires are positioned so as to provide electrical connections between circuit boards and electrical components such as motors, display units, and operation units. Generally, such electric wires are held by clamps, which serve as holding members, so that the electric wires do not move from predetermined positions.

For example, a wire holding mechanism having a clamp has been proposed. The clamp includes a clamp body, which is flexible, thin plate-shaped, and made of flame-retardant plastic; an attaching portion, which is formed on the first end of the clamp body so that the clamp body can be attached using a single support; and a bent portion, which is formed on the second end of the clamp body so that, when the clamp body is attached using the single support, an electric wire can be clamped between the bent portion and a fixing member located near the attaching position. The clamp is fixed to a predetermined member at the attaching portion using a screw, which serves as a fastening member.

However, using the wire holding mechanism as mentioned above a screw, which serves as the fastening member, is necessary to fix the clamp (which serves as the holding member), to the predetermined member.

Thus, problems may arise in that a predetermined operation has to be performed so as to attach the clamp, and in that the electric wire may not be properly held by the clamp because the side of the clamp that is not fixed by a screw may be lifted up.

### SUMMARY

The present invention provides a wire holding mechanism including a holding member that restricts movement of the wire when the holding member is attached to a predetermined member, and that can be attached to the predetermined member without using a fastening member.

The present invention also provides an image forming apparatus including the wire holding mechanism and a method of maintaining a wire.

In an embodiment of the present invention, a wire holding mechanism for holding a wire that is routed along a frame is provided. The mechanism includes: the frame which includes an attachment surface, the attachment surface having an attachment hole and an engagement portion; and a holding member that is detachably attached to the attachment hole. The holding member includes: a rotation shaft that is inserted into the attachment hole from a first end thereof and rotatably supported by the attachment hole; a flange portion formed on the first end of the rotation shaft, the flange portion preventing the holding member from coming out of the attachment hole; an arm portion extending from a second end of the rotation shaft radially outward in a direction crossing an axial direction of the rotation shaft, the arm portion being rotatable above the attachment surface with a predetermined distance therebetween, and a leg portion located between the flange portion and the arm portion, the leg portion maintaining the predetermined distance. The holding member is inserted into the attachment hole in a first position thereof, and, in a second position thereof at which the holding member is rotated by a predetermined angle with respect to the first position, the arm portion engaging the engagement portion and restricting movement of the wire.

In a preferred embodiment, the attachment hole includes a supporting portion that supports the rotation shaft, and a passage portion that allows the flange portion to pass therethrough when the holding member is in the first position, but does not allow the flange portion to pass therethrough when the holding member is in the second position.

In a preferred embodiment, the angle between the direction in which the arm portion extends and the direction in which the flange portion extends is substantially 90 degrees with respect to the rotational direction of the rotation shaft.

In a preferred embodiment, the engagement portion stand on the attachment surface is positioned on the rotational path of the arm portion and includes an engagement hole engageable with the arm portion.

In a preferred embodiment, the leg portion is formed on each side of the rotation shaft.

In a preferred embodiment, the leg portion includes a contact portion that contacts the attachment surface, the contact portion having an arc shape.

In a preferred embodiment, the holding member is attached to the attachment surface such that the leg portion of the holding member is subjected to an elastic deformation and the holding member nips the attachment surface between the leg portion and the flange portion using an elastic force generated by the elastic deformation.

According to an embodiment of the present invention, an image forming apparatus including the wire holding mechanism is provided.

In an embodiment of the present invention, a wire holding mechanism is provided that restricts movement of the wire when the wire holding mechanism attached to a predetermined member, the attachment being achieved without using a fastening member. In an embodiment of the present invention, an image forming apparatus including the wire holding mechanism is provided.

Additional features and advantages are described herein, and will be apparent from the following Detailed Description and the figures.

### BRIEF DESCRIPTION OF THE FIGURES

In the accompanying drawings:

FIG. 1 is a schematic view of components in a printer;

FIG. 2 is a perspective view of an embodiment of a fusing unit;

FIG. 3 is a sectional view of an embodiment of the fusing unit;

FIG. 4A is a perspective view of an embodiment of a holding member;

FIG. 4B is a perspective view of an embodiment of the holding member viewed from a downward direction of FIG. 4A;

FIG. 5 is a perspective view illustrating the attachment hole before an insertion portion of the holding member is inserted therein;

FIG. 6 is a perspective view illustrating when the insertion portion of the holding member is inserted into the attachment hole and the holding member is in a first position; and

FIG. 7 is a perspective view illustrating when the insertion portion of the holding member is inserted into the attachment hole and the holding member is in a second position.

### DETAILED DESCRIPTION

Hereinafter, embodiments of the present invention are described with reference to the drawings.

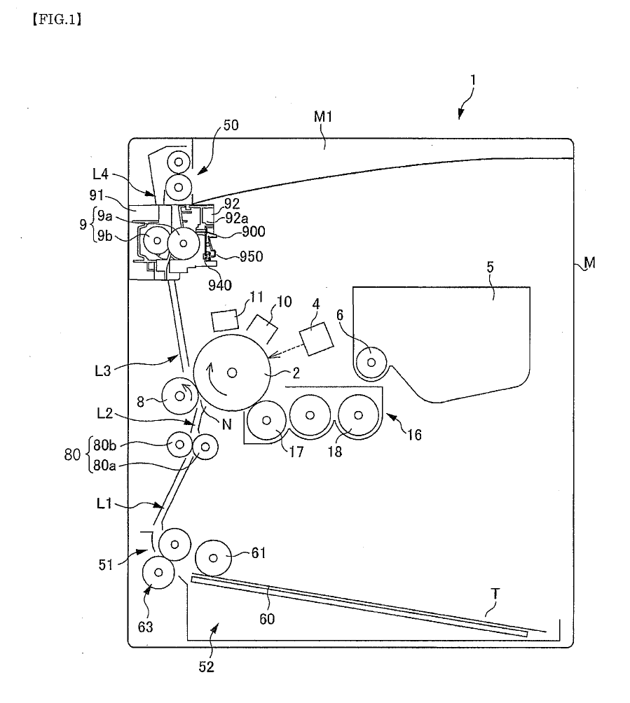

Referring to FIG. 1, the overall structure of a printer 1, which is an image forming apparatus according to an embodiment of the present invention, is described. FIG. 1 is a left side view illustrating how various components of the printer 1 are arranged. The side (the right side of FIG. 1) toward which a sheet T is ejected from a sheet ejecting unit 50 described below refers to the “front side” of the printer 1.

The printer 1 includes an image forming section and a sheet feeding/ejecting section. The image forming section forms an image on the sheet T based on an image data. The sheet feeding/ejecting section feeds the sheet T to the image forming section and ejects the sheet T on which the image has been formed.

As shown in FIG. 1, the image forming section includes a photosensitive drum 2, a charging unit 10, a laser scanner unit 4, a developing unit 16, a toner cartridge 5, a toner supplying unit 6, a transfer roller 8, a fusing unit 9, and a drum cleaning unit 11.

The sheet feeding/ejecting section includes a sheet feed cassette 52, a pair of resist rollers 80, and a transport path L for transporting the sheet T.

The photosensitive drum 2 has a cylindrical shape, and serves as an image bearing member. The photosensitive drum 2 is located in the main body M so as to be rotatable around a rotation shaft that extends perpendicular to the paper surface of FIG. 1. An electrostatic latent image is formed on the photosensitive drum 2.

The charging unit 10 is positioned above the photosensitive drum 2. The charging unit 10 uniformly charges a surface of the photosensitive drum 2 with positive charges.

The laser scanner unit 4 is located above the photosensitive drum 2 at a position where it is separated from the photosensitive drum 2. The laser scanner unit 4 includes a laser light source, a polygon mirror, a motor for driving the polygon mirror, and the like (not shown).

The laser scanner unit 4 irradiates light to the surface of the photosensitive drum 2 based on the image data that has been outputted from external equipment such as a personal computer (PC). As the laser scanner unit 4 irradiates light to the surface of the photosensitive drum 2, electric charges are removed from the surface of the photosensitive drum 2 where the light is irradiated to. Thus, an electrostatic latent image is formed on the surface of the photosensitive drum 2.

The developing unit 16 is located in front of the photosensitive drum 2 (on the right side of FIG. 1). The developing unit 16 develops a monochrome (usually, black) toner image on the electrostatic latent image formed on the photosensitive drum 2. The developing unit 16 includes a developing roller 17, which can be positioned so as to face the photosensitive drum 2, and a stirring roller 18 for stirring toner.

The toner cartridge 5 contains toner to be supplied to the developing unit 16.

The toner supplying unit 6 supplies the toner, which is contained in the toner cartridge 5, to the developing unit 16.

The drum cleaning unit 11 is located behind the photosensitive drum 2 (on the left side of FIG. 1). The drum cleaning unit 11 removes toner and foreign matter remaining on the surface of the photosensitive drum 2.

The transfer roller 8 transfers the toner image, which has been developed on the surface of the photosensitive drum 2, onto the sheet T. A transfer bias is applied from a voltage applying unit (not shown) to the transfer roller 8, so that the toner image, which has been developed on the photosensitive drum 2, can be transferred onto the sheet T.

The transfer roller 8 can be in contact with or separated from the photosensitive drum 2. More specifically, the transfer roller 8 can be moved to a contact position and to a separated position. At the contact position, the transfer roller 8 contacts the photosensitive drum 2; at the separated position, the transfer roller 8 is separated from the photosensitive drum 2. The transfer roller 8 is moved to the contact position so as to transfer the toner image, which has been developed on the photosensitive drum 2, onto the sheet T. At other times, the transfer roller 8 is moved to the separated position.

The sheet T is nipped between the photosensitive drum 2 and the transfer roller 8, and pressed against the surface (the surface on which the toner image has been developed) of the photosensitive drum 2. A transfer nip N is thus formed, and the toner image, which has been developed on the photosensitive drum 2, is transferred onto the sheet T.

The fusing unit 9 fuses the toner which has been transferred onto the sheet T and forms the toner image, and fixes the toner to the sheet T. The fusing unit 9 includes a heating roller 9a and a pressure roller 9b. The heating roller 9a is heated by heaters, and the pressure roller 9b is pressed against the heating roller 9a. The heating roller 9a and the pressure roller 9b nip and transport the sheet T, onto which the toner image has been transferred. While the sheet T is being nipped and transported between the heating roller 9a and the pressure roller 9b, the toner that has been transferred onto the sheet T is fused and fixed.

The sheet feed cassette 52 is located in a lower part of the main body M. The sheet feed cassette 52 is located in the main body M such that the sheet feed cassette 52 can be horizontally pulled out toward the front side of the main body M (toward the right side of FIG. 1). The sheet feed cassette 52 includes a sheet holding plate 60, on which the sheet T is placed. The sheet feed cassette 52 stores a plurality of the sheets T stacked on the sheet holding plate 60. A cassette sheet feeding unit 51 is located at the end of the sheet feed cassette 52 from which the sheet T is fed (the end at the left side of FIG. 1). The cassette sheet feeding unit 51 feeds out the sheet T, which is stored in the sheet feed cassette 52, to a transport path L.

The cassette sheet feeding unit 51 includes a double feeding prevention mechanism having a forward feed roller 61 and a pair of rollers 63. The forward feed roller 61 picks up the sheet T that is placed on the sheet holding plate 60, and the pair of rollers 63 feed the sheet T to the transport path L one by one.

The transport path L, for transporting the sheet T therethrough, extends from the cassette sheet feeding unit 51 to the sheet ejecting unit (output unit) 50. The transport path L includes a first transport path L1 from the cassette sheet feeding unit 51 to the pair of resist rollers 80, a second transport path L2 from the pair of resist rollers 80 to the transfer roller 8, a third transport path L3 from the transfer roller 8 to the fusing unit 9, and a fourth transport path L4 from the fusing unit 9 to the sheet ejecting unit 50.

The first to fourth transport paths L1 to L4 extend substantially upward.

The pair of resist rollers 80 are located upstream of the transfer roller 8 with respect to the transport direction of the sheet T (the lower side of FIG. 1). When the pair of resist rollers 80 are not rotating, a leading edge of the sheet T, that has been fed from the pair of rollers 63, temporarily contacts the pair of resist rollers 80. Then, the pair of resist rollers 80 are rotated so as to feed the sheet T downstream, in the transport direction. The pair of resist rollers 80 also serve to correct any skewing (oblique feeding) of the sheet T, and to adjust timing with the toner image.

The sheet ejecting unit 50 is located at one end of the fourth transport path L4. The sheet ejecting unit 50 is located in an upper part of the main body M. The sheet ejecting unit 50 has an opening directed toward the front of the main body M (the right side of FIG. 1). The sheet ejecting unit 50 ejects the sheet T, on which toner has been fixed by the fusing unit 9, outside of the main body M.

An ejected-sheet stacking area M1 is located adjacent to the opening of the sheet ejecting unit 50. The ejected-sheet stacking area M1 is located on an upper surface (outer surface) of the main body M. The ejected-sheet stacking area M1 is defined by a depression formed in the upper surface of the main body M. The bottom of the ejected-sheet stacking area M1 constitutes a part of the upper surface of the main body M. The sheet T, on which an image has been transferred and which has been ejected from the sheet ejecting unit 50, is stacked and accumulated in the ejected-sheet stacking area M1.

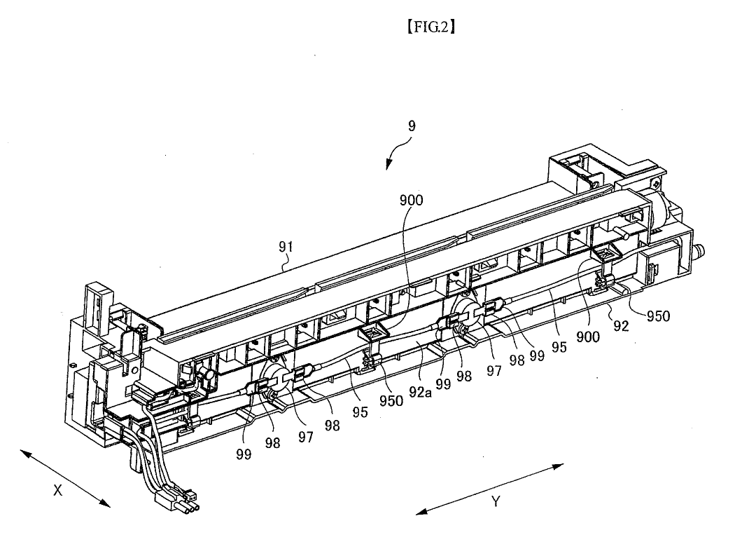

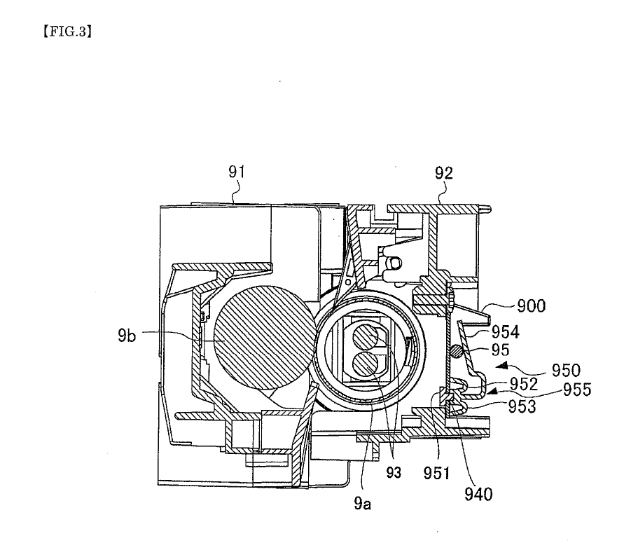

Referring to FIGS. 2 and 3, the fusing unit 9 is illustrated. Electric wires 95 are located on an outer surface (attachment surface) 92a of the fusing unit 9.

FIG. 2 is a perspective view of the fusing unit 9. FIG. 3 is a sectional view of the fusing unit 9. The fusing unit 9 is unitized and can be attached to or detached from the main body M as a unit.

As shown in FIG. 2, the fusing unit 9 includes a first cover frame 91 and a second cover frame 92, which are oblong (in Y directions) and have been assembled together.

As shown in FIG. 3, the pressure roller 9b is located inside the first cover frame 91. The heating roller 9a is located inside the second cover frame 92. The pressure roller 9b is pressed against the heating roller 9a with a compression coil spring (not shown).

Halogen heaters 93, which serve as heat sources, are located inside the heating roller 9a. Electric wires 95 are located so as to supply electric power to the halogen heaters 93. Thermostats 97 are located so as to prevent the halogen heaters 93 from excessively heating the heating roller 9a.

As shown in FIG. 2, the electric wires 95, which serve as wiring, and the thermostats 97 are located on the outer surface (attachment surface) 92a of the second cover frame 92.

The thermostats 97 are located on the outer surface (attachment surface) 92a of the second cover frame 92 with predetermined intervals therebetween. Two terminals 98 are attached to each of the thermostats 97.

The electric wires 95 are located along the outer surface (attachment surface) 92a of the second cover frame 92. The electric wires 95 are conducting members through which electric power is supplied to the halogen heaters 93 and other components from a power source (not shown). Each of the electric wires 95 is a linear member including a linear inner conductor and an insulator covering the inner conductor.

Terminals 99 are attached to the ends of each of the electric wires 95. Each of the terminals 99 is connected to one of the corresponding terminals 98 of the thermostats 97 by being crimped.

Thus, the electric wires 95 are connected to the thermostats 97. In an embodiment, the thermostats 97 and the electric wires 95 are serially disposed in Y directions in an alternating manner.

According to an embodiment, a wire holding mechanism is provided that includes an engagement portion 900 and a holding member 950 to fix the electric wires 95 to the outer surface (attachment surface) 92a of the second cover frame 92.

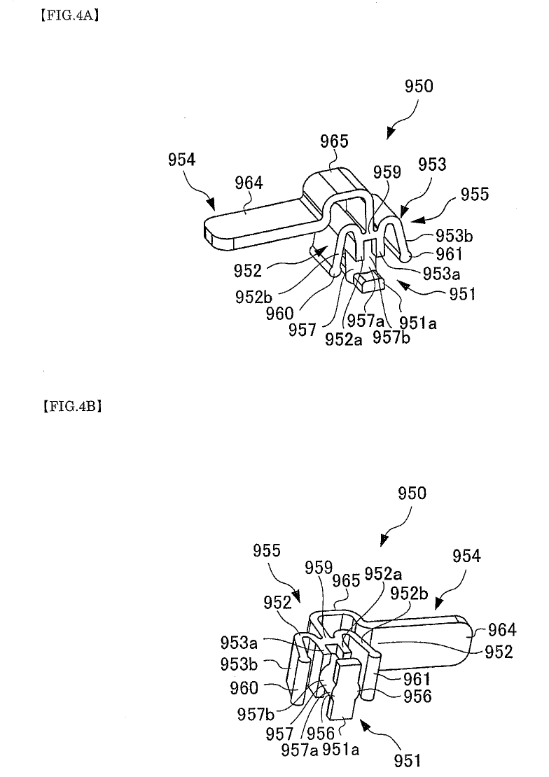

Referring to FIGS. 4A to 7, the wire holding mechanism, including the engagement portion 900 and the holding member 950 are illustrated.

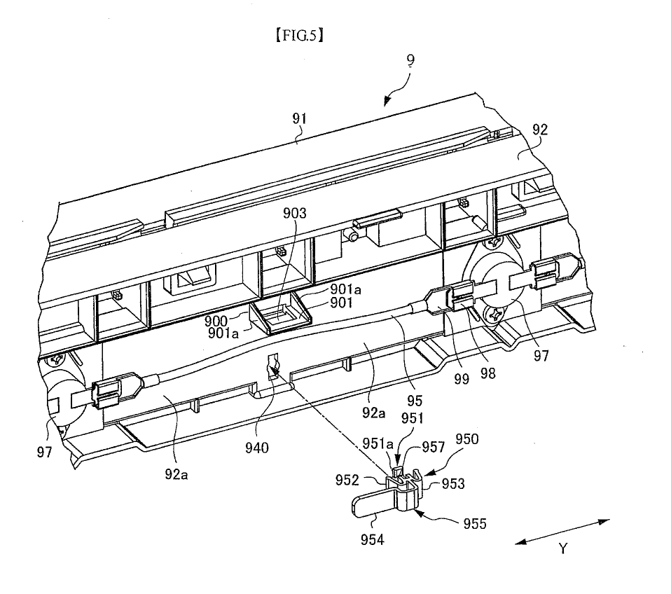

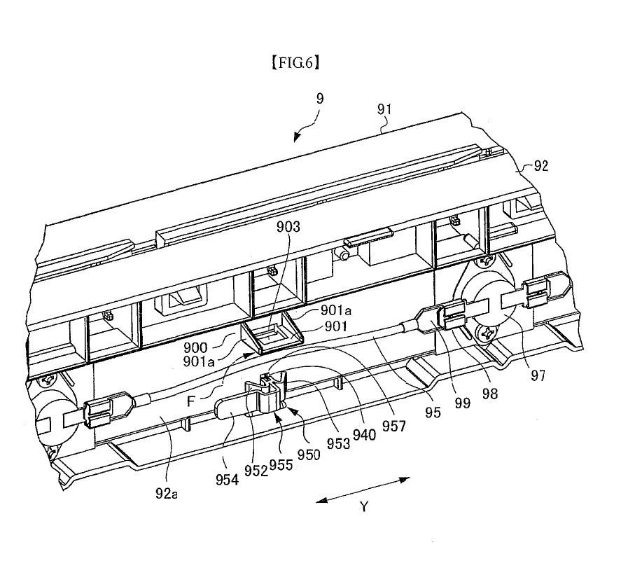

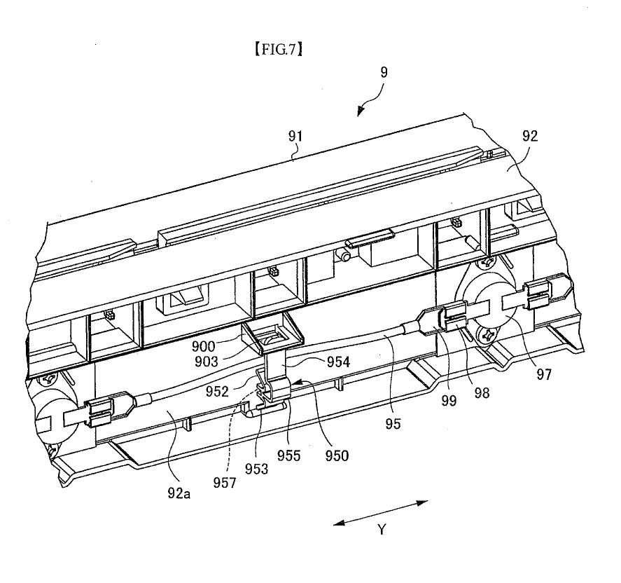

FIG. 4A is a perspective view of the holding member 950. FIG. 4B is a perspective view of the holding member 950 viewed from a direction that is opposite to that of FIG. 4A. FIG. 5 is a perspective view illustrating an attachment hole 940 before an insertion portion 951 of the holding member 950 is inserted therein. FIG. 6 is a perspective view illustrating the insertion portion 951 of the holding member 950 inserted into the attachment hole 940, with the holding member 950 being in a first position. FIG. 7 is a perspective view illustrating the insertion portion 951 of the holding member 950 inserted into the attachment hole 940, with the holding member 950 being in a second position.

A wire holding mechanism according to an embodiment includes: the second cover frame 92 having the outer surface (attachment surface) 92a in which the attachment hole 940 is formed, the outer surface serving as a predetermined surface; the holding member 950 that restricts separation of the electric wires 95 from the outer surface (attachment surface) 92a, the electric wires 95 serving as wiring and being located along the outer surface (attachment surface) 92a; and the engagement portion 900 formed on the outer surface (attachment surface) 92a, the engagement portion 900 restricting movement or deformation of an arm portion 954 of the holding member 950 as described below.

As shown in FIGS. 4A and 4B, the holding member 950 includes the insertion portion 951 and a protruding portion 955 that is continuously formed on a side of the insertion portion 951. The holding member 950 is entirely made of a resin material.

The insertion portion 951 includes a rotation shaft 957 and a rectangular portion (flange portion) 951a. The insertion portion 951 can be inserted into and pulled out of the attachment hole 940.

The rotation shaft 957 has a cylindrical shape. From the first end of the rotation shaft 957, the rectangular portion (flange portion) 951a extends in opposite radial directions. Sides of the rectangular portion (flange portion) 951a are shorter than the diameter of the rotation shaft 957.

The attachment hole 940 has a shape that is similar to that of the first end of the rotation shaft 957. The attachment hole 940 has a supporting portion at the center thereof, and passage portions at ends thereof. The supporting portion rotatably supports the rotation shaft 957. Through the passage portions, the rectangular portion (flange portion) 951a can be inserted.

The insertion portion 951 can be rotated around the rotation shaft 957 between a first position and a second position. At the first position, an end surface of the insertion portion 951 can be received in the shape of the attachment hole 940, and the insertion portion 951 can be inserted into or removed from the attachment hole 940. At the second position, when the insertion portion 951 is inserted into the attachment hole 940 and rotated by 90 degrees around the rotation shaft 957, insertion and removal of the insertion portion 951 are restricted.

The protruding portion 955 is continuously formed from the second end of the rotation shaft 957. The protruding portion 955 includes a first leg portion 952, a second leg portion 953, and the arm portion 954. The first leg portion 952 and the second leg portion 953 extend toward the first end of the rotation shaft 957. When the insertion portion 951 is inserted into the attachment hole 940, the first leg portion 952 and the second leg portion 953 are in contact with the outer surface (attachment surface) 92a.

The first leg portion 952 and the second leg portion 953 are located so as to be bilaterally symmetric to each other with respect to the rotation shaft 957 (in a direction perpendicular to the longitudinal direction of the rectangular portion (flange portion) 951a).

The first leg portion 952 includes a short leg portion 952a and a long leg portion 952b. Likewise, the second leg portion 953 includes a short leg portion 953a and a long leg portion 953b.

In the first leg portion 952, the short leg portion 952a is positioned inward of the long leg portion 952b. Likewise, in the second leg portion 953, the short leg portion 953a is positioned inward of the long leg portion 953b. The short leg portions 952a and 953a are connected to each other through a connecting portion 959.

The short leg portions 952a and 953a have flat end surfaces that extend substantially parallel to the outer surface (attachment surface) 92a when the insertion portion 951 is inserted into the attachment hole 940. The long leg portions 952b and 953b, respectively, have arc portions 960 and 961 at ends thereof.

In the first leg portion 952, the short leg portion 952a and the long leg portion 952b form a substantial U-shape that is open toward the rectangular portion (flange portion) 951a. The same applies to the second leg portion 953. When the insertion portion 951 is inserted into the attachment hole 940, the long leg portions 952b and 953b are in contact with the outer surface (attachment surface) 92a. This structure serves to maintain a distance between an engaging piece 964 of the arm portion 954 (described below) and the outer surface (attachment surface) 92a. Moreover, the long leg portions 952b and 953b are elastically deformed and extended sideways, so that the long leg portions 952b and 953b contact the outer surface (attachment surface) 92a with an elastic force. In this position, the long leg portions 952b and 953b and the rectangular portion (flange portion) 951a, which is positioned behind the attachment hole 940, nip the outer surface (attachment surface) 92a. Thus, the holding member 950 is fixed to the outer surface (attachment surface) 92a.

When the holding member 950 (protruding portion 955) is rotated in this position, the ends of the short leg portions 952a and 953a and the arc portions 960 and 961 that are the ends of the long leg portions 952b and 953b slide along the outer surface (attachment surface) 92a.

The arm portion 954 includes the engaging piece 964 and a connecting piece 965. The engaging piece 964 extends in a direction that is substantially perpendicular to the rotation shaft 957. One end of the connecting piece 965 is connected to the engaging piece 964 and the other end of the connecting piece 965 is connected to the connecting portion 959. The engaging piece 964 extends on the first leg portion 952 side.

As the insertion portion 951 is rotated from the first position to the second position, the engaging piece 964 (arm portion 954) is moved from a separated position where the engaging piece 964 is separated from the engagement portion 900 (described below) to an engagement position where the engaging piece 964 engages with the engagement portion 900.

In the separated position, movement or deformation of the engaging piece 964 (arm portion 954) in a direction away from the outer surface (attachment surface) 92a is not restricted. In the engagement position, movement or deformation of the engaging piece 964 in a direction away from the outer surface (attachment surface) 92a is restricted. In the engagement position, rotation of the engaging piece 964 (arm portion 954) is also restricted.

When the engaging piece 964 is in the engagement position, the engaging piece 964 and the outer surface (attachment surface) 92a nip the electric wire 95 therebetween.

Thus, movement of the electric wire 95 in a direction away from the outer surface (attachment surface) 92a can be restricted.

If a force greater than a predetermined strength is applied in a rotational direction to the holding member 950, the engaging piece 964 is disengaged from the engagement portion 900, so that the engaging piece 964 can be rotated. When the engaging piece 964 is rotated from the engagement position, the engaging piece 964 does not restrict movement of the electric wire 95 in a direction away from the outer surface (attachment surface) 92a.

In the outer surface (attachment surface) 92a of the second cover frame 92, a plurality of the attachment holes 940 are linearly arranged with predetermined intervals in Y directions (see FIG. 2). Through each of the attachment holes 940, the rotation shaft 957 of the holding member 950 is respectively inserted. The attachment hole 940 has substantially the same shape and size as the insertion portion 951.

On the outer surface (attachment surface) 92a of the second cover frame 92, a plurality of the engagement portions 900 are linearly arranged with predetermined intervals in Y directions. The engagement portions 900 are located at positions corresponding to the attachment holes 940 (with respect to Y directions, see FIG. 2). The engagement portions 900 can be integrally formed with the outer surface (attachment surface) 92a of the second cover frame 92.

Each of the engagement portions 900 includes a wall portion 901 and an engagement hole 903 formed in the wall portion 901. The wall portion 901 extends from the outer surface (attachment surface) 92a of the second cover frame 92 substantially perpendicularly (in a direction from which the rotation shaft 957 is inserted).

The wall portion 901 includes upright portions 901a as integral parts thereof. The upright portions 901a provide the wall portion 901 with strength greater than a predetermined value.

The engagement hole 903 extends though the wall portion 901. The engagement hole 903 has a rectangular shape that is oblong in Y directions. One end of the engaging piece 964 is inserted (fitted) into the engagement hole 903.

When the arm portion 954 (engaging piece 964) is in the engagement position, the engagement portion 900 restricts movement or deformation of the arm portion 954 (engaging piece 964) in a direction away from the outer surface (attachment surface) 92a. Thus, movement of the electric wire 95 in a direction away from the outer surface (attachment surface) 92a is restricted, so that the electric wire 95 can be pressed to the outer surface (attachment surface) 92a of the second cover frame 92.

On the other hand, when the arm portion 954 (engaging piece 964) is in the separated position, the engagement portion 900 does not restrict the movement of the arm portion 954 (engaging piece 964) in a direction away from the outer surface (attachment surface) 92a.

If a force exceeding a predetermined force is applied to the holding member 950 in a rotational direction, when the arm portion 954 (engaging piece 964) is in the engagement position and the rotation is restricted, the engagement portion 900 will become disengaged from the arm portion 954 (engaging piece 964).

When the engagement portion 900 is disengaged from the arm portion 954 (engaging piece 964), the engagement portion 900 is changed from a state in which the engagement portion 900 restricts movement of the electric wire 95 via the arm portion 954 (engaging piece 964) to a state in which the engagement portion 900 does not restrict movement of the electric wire 95.

Referring to FIGS. 5 to 7, the wire holding mechanism is illustrated.

As shown in FIG. 5, the electric wire 95 is located on the second cover frame 92 along the outer surface (attachment surface) 92a. Before the holding member 950 is attached, movement of the electric wire 95, which is located along the outer surface (attachment surface) 92a of the second cover frame 92, including movement in a direction away from the outer surface (attachment surface) 92a, is not substantially restricted.

As shown in FIG. 5, by inserting the insertion portion 951 into the attachment hole 940, while the insertion portion 951 is in the same position as the first position in terms of a rotation direction, the holding member 950 can be attached to the outer surface (attachment surface) 92a of the second cover frame 92.

As shown in FIG. 6, when the insertion portion 951 is in the first position, the respective arc portions 960 and 961 of the first leg portion 952 and the second leg portion 953 are in contact with the outer surface (attachment surface) 92a of the second cover frame 92. The arm portion 954 is located such that the longitudinal direction of the engaging piece 964 coincides with a Y direction, and such that the arm portion 954 is separated from the outer surface (attachment surface) 92a by a predetermined distance.

When a force is applied to the holding member 950 in a direction shown by an arrow F, the holding member 950 rotates around the rotation shaft 957 in the direction shown by the arrow F. At this time, the holding member 950 can smoothly rotate, since the first leg portion 952 and the second leg portion 953 are elastic and the arc portions 960 and 961 slide along the outer surface (attachment surface) 92a. Moreover, the holding member 950 is prevented from leaning or falling down to one side, since the first leg portion 952 and the second leg portion 953 contact the outer surface (attachment surface) 92a on respective sides of the rotation shaft 957 (at positions opposite each other).

As shown in FIG. 7, by rotating the holding member 950, the position of the insertion portion 951 is changed from the first position to the second position.

When the insertion portion 951 is rotated to the second position, the insertion portion 951 is prevented from coming out of the attachment hole 940.

By rotating the holding member 950, the arm portion 954 is moved to the engagement position so as to be engaged with the engagement portion 900. More specifically, the engaging piece 964 of the arm portion 954 is inserted into the engagement hole 903 of the engagement portion 900. When the engaging piece 964 is inserted into the engagement hole 903 and engaged with the engagement hole 903, movement (deformation) of the arm portion 954 (engaging piece 964) in a direction away from the outer surface (attachment surface) 92a and rotation of the arm portion 954 around the rotation shaft 957 is restricted.

With the wire holding mechanism according to the present invention, by attaching the holding member 950 to the outer surface (attachment surface) 92a of the second cover frame 92 and by rotating the holding member 950, movement of the electric wire 95 can be restricted. Thus, movement of the electric wire 95 is restricted using a simple operation.

By rotating the wire holding mechanism according to an embodiment, the engagement portion 900 is disengaged from the arm portion 954 (engaging piece 964). Thus, the wire holding mechanism can be changed from a state restricting movement of the electric wire 95 to a state not restricting movement of the electric wire 95 using a simple operation.

With the wire holding mechanism according to an embodiment, the holding member 950 is attached to the outer surface (attachment surface) 92a of the second cover frame 92 without using fastening members such as screws or the like. Thus, the wire holding mechanism restricts movement of the electric wire using a small number of components.

With the wire holding mechanism according to an embodiment, the arm portion 954 of the holding member 950 and the outer surface (attachment surface) 92a of the second cover frame 92 nip the electric wire 95 therebetween so as to restrict movement of the electric wire 95. Thus, the wire holding mechanism can securely suppress movement of the electric wire 95.

With the wire holding mechanism according to an embodiment, since the engagement portion 900 determines the position of the holding member 950 and restricts rotation of the holding member 950, even if deformation of the holding member 950 occurs due to heat, moisture, or aging, the holding mechanism continues to restrict movement of the electric wire 95.

With the wire holding mechanism according to an embodiment, the holding member 950 may be made of an elastic resin. This extends the range of material selection for the wire holding mechanism.

Since the first and second leg portions 952 and 953 are elastic and the respective arc portions 960 and 961 of the first and second leg portions 952 and 953 slide along the outer surface (attachment surface) 92a, the holding member 950 smoothly rotate (slide). Moreover, since the first and the second leg portions 952 and 953 contact the outer surface (attachment surface) 92a at positions opposite each other, where the rotation shaft 957 is located therebetween, the holding member 950 is prevented from leaning or falling down to one side.

Heretofore, embodiments of the present invention have been described. However, the present invention is not limited to the above-described embodiments and can be carried out in various forms. For example, in the description of the above embodiments, the printer 1 is used as the image forming apparatus. However, the present invention is not limited thereto, and the image forming apparatus may be a monochrome copier, a color copier, a facsimile, a multi-functional peripheral, or the like.

In an embodiment, the engagement hole 903 is formed such that the engaging piece 964 of the arm portion 954 of the holding member 950 is inserted into the engagement hole 903 with a predetermined margin. However, the present invention is not limited thereto. The engagement hole 903 may be formed such that the engaging piece 964 of the arm portion 954 is tightly fit into the engagement hole 903.

In an embodiment, the electric wire 95 is used for wiring. However, the present invention is not limited thereto. A line carrying electricity or signals, such as a signal line, an optical fiber, or the like, may be used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A wire holding mechanism for holding a wire that is routed along a frame, the wire holding mechanism comprising:
the frame including an attachment surface, the attachment surface having an attachment hole and an engagement portion; and
a holding member detachably attached to the attachment hole, the holding member including a rotation shaft inserted into the attachment hole from a first end thereof and rotatably supported by the attachment hole, a flange portion formed on the first end of the rotation shaft, the flange portion preventing the holding member from coming out of the attachment hole, an arm portion extending from a second end of the rotation shaft radially outward, the arm portion being rotatable above the attachment surface and having a predetermined distance therebetween, a leg portion located between the flange portion and the arm portion, the leg portion maintaining the predetermined distance, and the holding member can be inserted into the attachment hole at a first position, and, move to a second position wherein the holding member is rotated by a predetermined angle from the first position, the arm portion engages the engagement portion and restricts movement of the wire.

2. The wire holding mechanism according to claim 1,
wherein the attachment hole includes a supporting portion that supports the rotation shaft and a passage portion that allows the flange portion to pass therethrough when the holding member is in the first position, but does not allow the flange portion to pass therethrough when the holding member is in the second position.

3. The wire holding mechanism according to claim 1,
wherein the angle between a direction in which the arm portion extends and a direction in which the flange portion extends is substantially 90 degrees with respect to a rotational direction of the rotation shaft.

4. The wire holding mechanism according to claim 1,
wherein the engagement portion extends from the attachment surface, is located on a rotational path of the arm portion, and has an engagement hole engageable with the arm portion.

5. The wire holding mechanism according to claim 1,
wherein the leg portion is formed at positions opposite each other, where the rotation shaft is located therebetween.

6. The wire holding mechanism according to claim 5,
wherein the leg portion includes an arc shape contact portion that contacts the attachment surface.

7. The wire holding mechanism according to claim 1,
wherein, the holding member is attached to the attachment surface, the leg portion of the holding member is subjected to an elastic deformation and the holding member nips the attachment surface between the leg portion and the flange portion using a force generated by elastic deformation.

8. An image forming apparatus comprising a wire holding mechanism for holding a wire that is routed along a frame, the wire holding mechanism including:
the frame including an attachment surface, the attachment surface having an attachment hole and an engagement portion; and
a holding member detachably attached to the attachment hole, the holding member including a rotation shaft inserted into the attachment hole from a first end thereof and rotatably supported by the attachment hole, a flange portion formed on the first end of the rotation shaft, the flange portion preventing the holding member from coming out of the attachment hole, an arm portion extending from a second end of the rotation shaft radially outward, the arm portion being rotatable above the attachment surface with a predetermined distance therebetween, a leg portion located between the flange portion and the arm portion, the leg portion maintaining the predetermined distance, and the holding member is inserted into the attachment hole at a first position, and, move to a second position where the holding member is rotated by a predetermined angle from the first position, the arm portion engages with the engagement portion and restricts movement of the wire.

9. A method of maintaining a wire in an image forming apparatus comprising:
routing a wire along a frame;
detachably attaching a holding member to an attachment hole in the frame, the holding member including a shaft inserted into the attachment hole from a first end thereof and rotatably supported by the attachment hole, a flange portion formed on the first end of the shaft, the flange portion preventing the holding member from inadvertently coming out of the attachment hole, an arm portion extending from a second end of the shaft radially outward, the arm portion being rotatable and having a predetermined distance between the frame, a leg portion maintaining the predetermined distance; and
inserting the holding member into the attachment hole at a first position, and, moving it to a second position where the arm portion engages the engagement portion and restricts movement of the wire.
